(19) United States
(12) Patent Application Publication
(10) Pub. No.: US 2015/0253287 A1
(43) Pub. Date: Sep. 10, 2015

(54) COMPUTER CONTROL SYSTEM AND METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: SHI-CHAO WANG, Wuhan (CN)

(21) Appl. No.: 14/612,883

(22) Filed: Feb. 3, 2015

(30) Foreign Application Priority Data
Mar. 10, 2014 (CN) 201410084762.4

(51) Int. Cl. G01N 27/72

(52) U.S. Cl. CPC G01N 27/72

(57) ABSTRACT

An energy-saving computer control system includes a motherboard, a magnetic field intensity inductor, and a micro processing controller. The magnetic field intensity inductor senses the proximity of a human body and the micro processing controller compares such information against a preset value of magnetic field intensity and a preset time. The micro processing controller further controls a state of the computer to be dormant or to wake up according to the comparison. A computer control method is also provided.

### FIELD

The subject matter herein generally relates to computer control systems.

### BACKGROUND

A user may need to remember to manually turn off a computer host when leaving the desk in order to save energy.

### BRIEF DESCRIPTION OF THE DRAWINGS

Implementations of the present technology will now be described, by way of example only, with reference to the attached figures.

FIG. 1 is a block diagram of an example embodiment of a computer control system of the present disclosure.

FIG. 2 and FIG. 3 are a flow chart of an example embodiment of a computer control method of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that applies throughout this disclosure will now be presented.

The term “comprising” means “including, but not necessarily limited to”; it specifically indicates open-ended inclusion or membership in a so-described combination, group, series and the like.

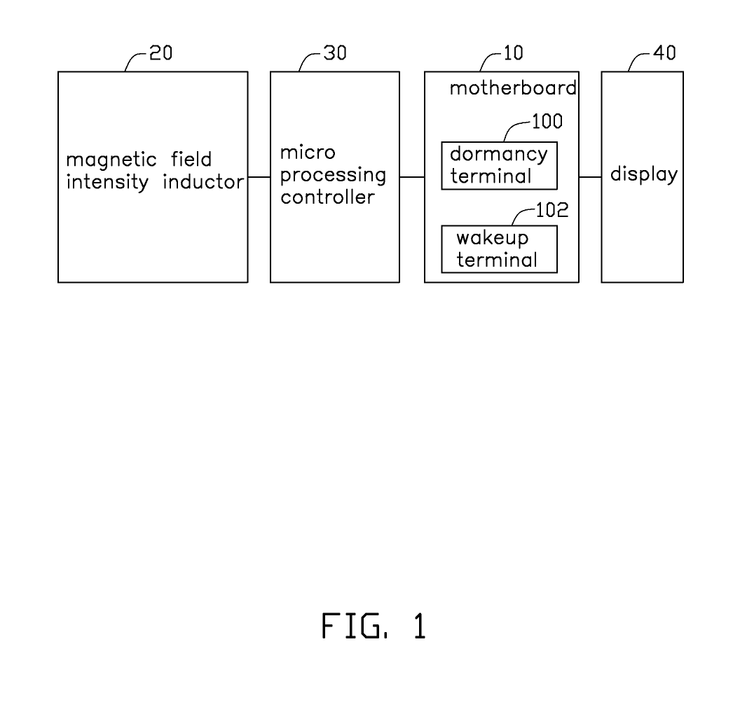

FIG. 1 illustrates a computer control system of the present disclosure. A computer control system can control the state of a computer. The computer control system in accordance with an exemplary embodiment includes a motherboard 10, a magnetic field intensity inductor 20, a micro processing controller 30, and a display 40.

Both the magnetic field intensity inductor 20 and the micro processing controller 30 can be attached to the motherboard 10. The motherboard 10 further comprises a dormancy terminal 100, and a wakeup terminal 102.

In at least one embodiment, both the magnetic field intensity inductor 20 and the motherboard 10 are coupled to the micro processing controller 30. The magnetic field intensity inductor 20 senses biological magnetic field intensity of a human body (MFIHB) around the computer, and transmits the intensity level thereof to the micro processing controller 30 in real-time. The micro processing controller 30 obtains the

MFIHB from the magnetic field intensity inductor 20.

The micro processing controller 30 can have a preset magnetic field intensity and a preset time. The micro processing controller 30 compares the level of the MFIHB transmitted by the magnetic field intensity inductor 20 with the preset magnetic field intensity, and obtains a result of comparison.

When the MFIHB transmitted by the magnetic field intensity inductor 20 is lower than the preset magnetic field intensity and such a state endures for the preset time, the micro processing controller 30 outputs a first control signal to the dormancy terminal 100 of the motherboard 10, and the motherboard 10 controls the computer to be dormant according to the first control signal transmitted by the micro processing controller 30.

When the level of the MFIHB transmitted by the magnetic field intensity inductor 20 is higher than the preset magnetic field intensity and such a state endures for the preset time, the micro processing controller 30 outputs a second control signal to the wakeup terminal 102 of the motherboard 10, and the motherboard 10 controls the computer to wake up according to the second control signal transmitted by the micro processing controller 30.

When the user leaves the computer, the level of the MFIHB detected by the magnetic field intensity inductor 20 decreases and remains in a decreased state. When the duration of the level of the MFIHB being detected by the magnetic field intensity inductor 20 is lower than the preset magnetic field intensity and the duration reaches the preset time, the micro processing controller 30 outputs the first control signal to the dormancy terminal 100 of the motherboard 10. The motherboard 10 controls the computer to be dormant according to the first control signal output by the micro processing controller 30, at the same time, the display 40 is turned off

When the user returns to the computer, the level of the MFIHB detected by the magnetic field intensity inductor 20 is increased and remains at an increased level. When the duration of the MFIHB being at a higher level continues for the preset time, the micro processing controller 30 outputs the second control signal to the wakeup terminal 102 of the motherboard 10, the motherboard 10 controls the computer to wake up according to the second control signal output by the micro processing controller 30, at the same time, the display 40 is turned on.

Until the level of the MFIHB transmitted by the magnetic field intensity inductor 20 is higher than the preset level for the preset time or lower than the preset level for the preset time, the computer maintains the existing or original state.

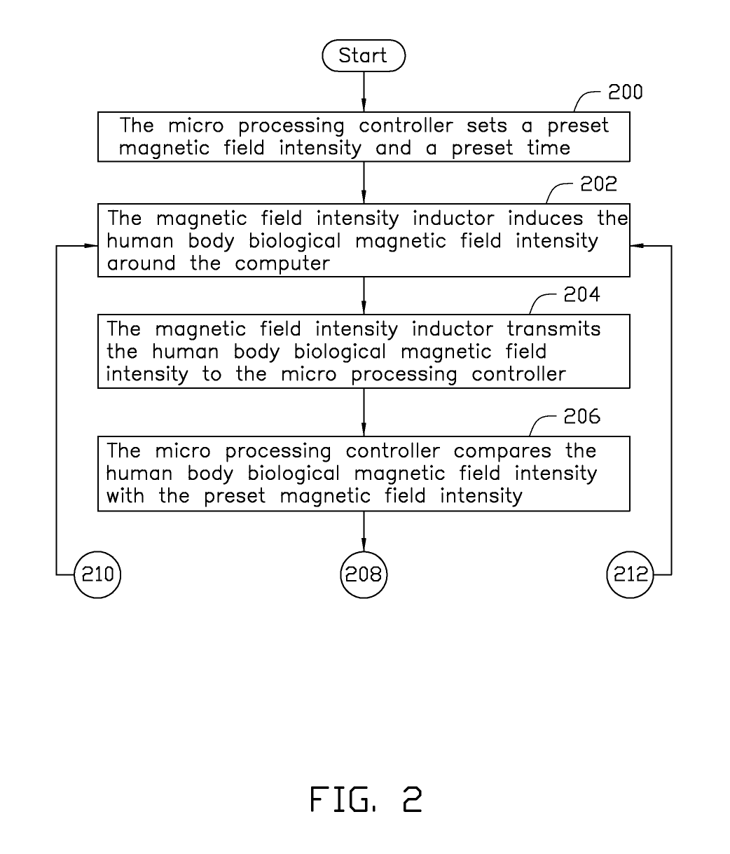

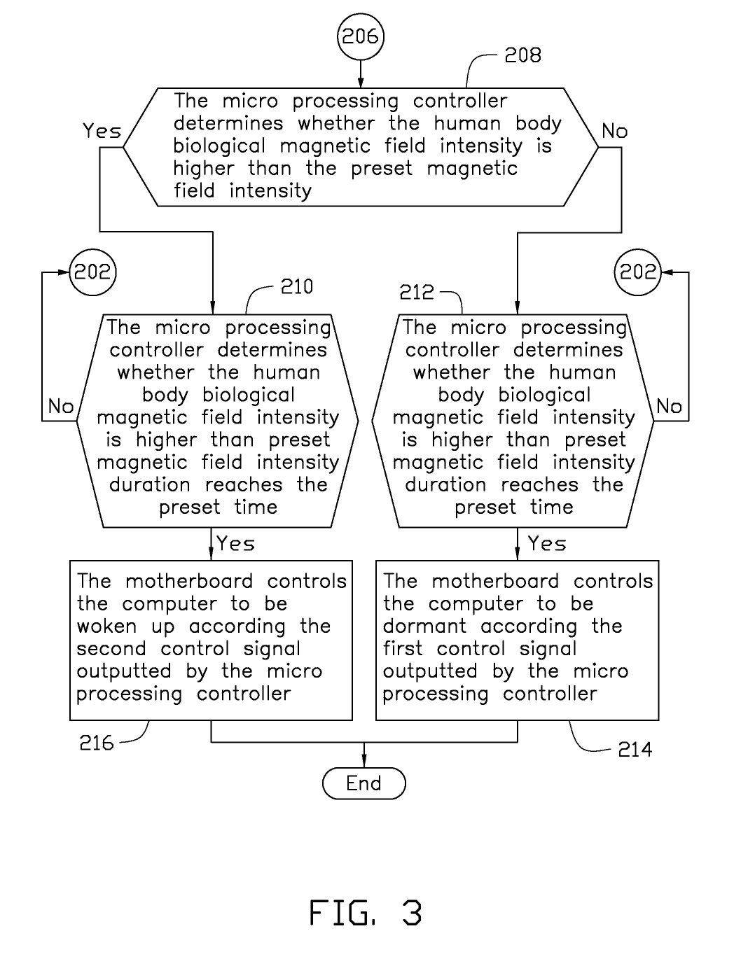

Referring to FIG. 2 and FIG. 3, a flowchart is presented in accordance with an example embodiment which is being thus illustrated. The example method is provided by way of example, as there are a variety of ways to carry out the method. The method described below can be carried out using the configurations illustrated in FIG. 1, for example, and various elements of these figures are referenced in explaining example method. Each block shown in FIG. 2 and FIG. 3 represents one or more processes, methods, or subroutines, carried out in the test method. Furthermore, the illustrated order of blocks is by example only and the order of the blocks can change. Additional blocks may be added or fewer blocks may be utilized, without departing from this disclosure. The computer control method can begin at block 200.

At block 200, the micro processing controller 30 sets a preset magnetic field intensity and a preset time.

At block 202, the magnetic field intensity inductor 20 senses the biological magnetic field intensity of a human body (MFIHB) around the computer.

At block 204, the magnetic field intensity inductor 20 transmits the intensity of the MFIHB to the micro processing controller 30.

At block 206, the micro processing controller 30 obtains the MFIHB intensity level from the magnetic field intensity inductor 20, and compares the received reading with the preset magnetic field intensity.

At block 208 , the micro processing controller 30 determines whether the received reading of the MFIHB is higher than the preset magnetic field intensity. If the MFIHB level is higher than the preset magnetic field intensity, block 212 is implemented, otherwise block S210 is implemented.

At block 210, the micro processing controller 30 determines whether the duration of a higher-level MFIHB reaches the preset time. If such duration reaches the preset time, block 216 is implemented, otherwise, the micro processing controller 30 remains in block 202.

At block 212, the micro processing controller 30 determines whether the duration of a lower-level MFIHB reaches the preset time. If such duration reaches the preset time, block 214 is implemented, otherwise the micro processing controller 30 remains in block 202.

At block 214, the micro processing controller 30 outputs a first control signal to the dormancy terminal 100 of the motherboard 10, and the motherboard 10 controls the computer to be dormant.

At block 216, the micro processing controller 30 outputs a second control signal to the wakeup terminal 102 of the motherboard 10, and the motherboard 10 controls the computer to wake up.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A computer control system for a computer comprising:
a motherboard;
a magnetic field intensity inductor sensing a biological magnetic field intensity of a human body (MFIHB) around the computer; and
a micro processing controller setting a preset magnetic field intensity and a preset time, and obtaining the MFIHB from the magnetic field intensity inductor; wherein the micro processing controller compares the level of the MFIHB with the preset magnetic field intensity;
wherein when the level of the MFIHB obtained by the micro processing controller is lower than the preset magnetic field intensity over the preset time, the micro processing controller outputs a first control signal to the motherboard, and the motherboard controls the computer to be dormant.

2. The computer control system of claim 1, wherein when the level of the MFIHB obtained by the micro processing controller is higher than the preset magnetic field intensity over the preset time, the micro processing controller outputs a second control signal to the motherboard, and the motherboard controls the computer to wake up.

3. The computer control system of claim 1, wherein the computer control system further comprises a display, the motherboard is coupled to the display, when the motherboard obtains the first control signal from the micro processing controller, the motherboard controls the display to be turned off.

4. The computer control system of claim 3, wherein when the motherboard obtains the second control signal from the micro processing controller, the motherboard controls the display to be turned on.

5. A computer control method for a computer comprising:
setting a preset magnetic field intensity and a preset time by a micro processing controller;
sensing a biological magnetic field intensity of a human body (MFIHB) around the computer by a magnetic field intensity inductor, and transmitting the level of the MFIHB to the micro processing controller; and
comparing the level of the MFIHB with the preset magnetic field intensity by the micro processing controller;
wherein when the duration that the level of the MFIHB obtained by the micro processing controller is lower than the preset magnetic field intensity over the preset time, the micro processing controller outputs a first control signal to the motherboard, and the motherboard controls the computer to be dormant.

6. The computer control method of claim 5, wherein when the level of the MFIHB obtained by the micro processing controller is higher than the preset magnetic field intensity over the preset time, the micro processing controller outputs a second control signal to the motherboard, and the motherboard controls the computer to wake up.
